(19) United States
(12) Patent Application Publication
(10) Pub. No.: US 2010/0088449 A1
(43) Pub. Date: Apr. 8, 2010

(54) DETECTING SYSTEM FOR DETECTING INSERTION OF EXPANSION CARD

(75) Inventors: KUO-HUA WANG, Tu-Cheng (TW); MEI-HUI CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/464,533

(22) Filed: May 12, 2009

(30) Foreign Application Priority Data
Oct. 8, 2008 (CN) 200820302358.X

(51) Int. Cl. G06F 13/00; G06F 1/26

(52) U.S. Cl. 710/301; 713/300

(57) ABSTRACT

A detecting system includes a slot, a controller and a power source terminal. The slot includes a first detecting pin and a second detecting pin. The first detecting pin is electrically connected to a detecting voltage terminal. The second detecting pin is connected to ground. The controller is electrically connected to the first detecting pin. The controller receives a high level voltage signal from the first detecting pin when an expansion card is not detected. The power source terminal is connected to the slot under control of the controller. On the condition that the first detecting pin is electrically connected to the second detecting pin. The controller receives a low level voltage signal from the first detecting pin. The controller is then triggered to connect the power source terminal to the slot to supply power to the expansion card.

### BACKGROUND

1. Technical Field

The present disclosure relates to a detecting system for detecting insertion of an expansion card and supplying power to the inserted expansion card.

2. Description of Related Art

A motherboard of a computer usually has a plurality of slots for receiving expansion cards to add functionality to the computer. A power supply is connected to the motherboard to provide power to the expansion cards. When the computer is used, the power supply may output power to all the slots of the motherboard whether the expansion cards are installed or not. In addition, the power of the slots may be turned on by accident, for example, a screw dropped onto a slot causing a short circuit, or a power circuit of the slot is connected by incorrectly inserting an expansion card. This may damage the computer or hurt an operator.

### BRIEF DESCRIPTION OF THE DRAWINGS

FIG. 1 is a schematic view of one embodiment of a detecting system for detecting insertion of an expansion card, and an electrical connection of a motherboard and the expansion card is shown.

FIG. 2 is an enlarged view of the expansion card of FIG. 1.

### DETAILED DESCRIPTION

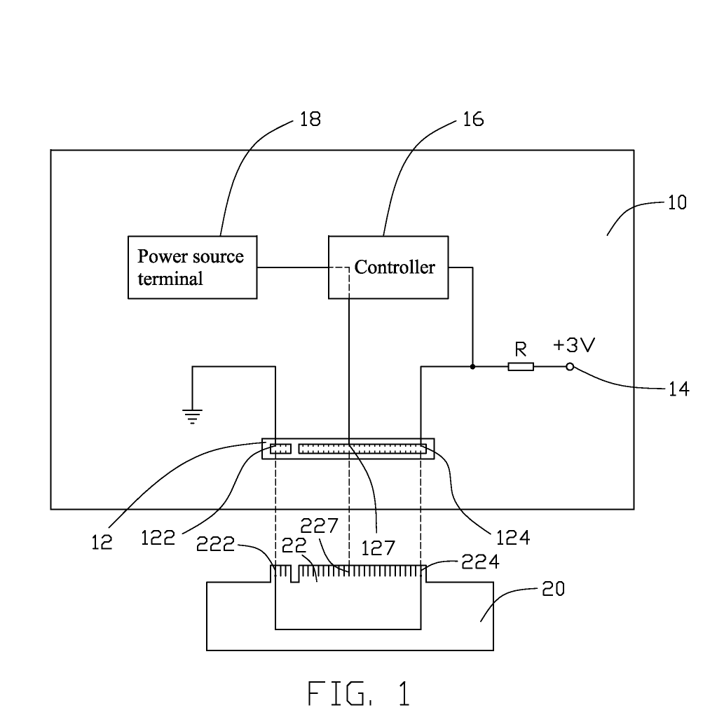

Referring to FIG. 1, in one embodiment, a detecting system is used in a motherboard 10 for detecting insertion of an expansion card 20 and supplying power to the inserted expansion card 20.

The detecting system includes a slot 12 for receiving the expansion card 20, a controller 16 electrically connected to the slot 12, and a power source terminal 18 connected to the slot 12 under control of the controller 16. The slot 12 includes a first detecting pin 124, a second detecting pin 122 and a power source pin 127. The first detecting pin 124 is electrically connected a +3V detecting voltage terminal 14 via a resistor. The second detecting pin 122 is connected to ground. The first detecting pin 124 is formed at one end of the slot 12, and the second detecting pin 122 is formed at an opposite end of the slot 12. The controller 16 is electrically connected to the first detecting pin 124. The power source terminal 18 is connected to the power source pin 127 through the controller 16.

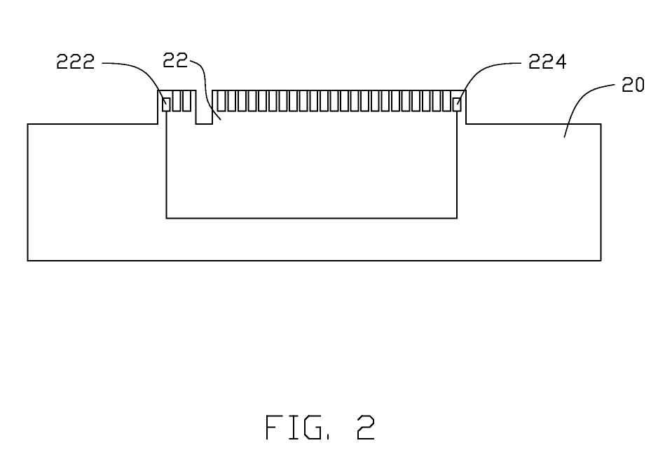

Referring to FIG. 1 and FIG. 2, the expansion card 20 to be detected includes an inserting portion 22. The inserting portion 22 includes a first detecting finger 224 for coupling to the first detecting pin 124, a second detecting finger 222 for coupling to the second detecting pin 122 and a power source finger 227 for coupling to the power source pin 127. The first detecting finger 224 and the second detecting finger 222 are a distance away from an insertion edge of the inserting portion 22, such that the expansion card 20 must be fully inserted into the slot 12 to be detected. The first detecting finger 224 is electrically connected to the second detecting finger 222.

When the slot 12 is unoccupied or the expansion card 20 is not completely inserted into the slot 12, the first detecting pin 124 is empty. The controller 16 receives a high level voltage signal from the first detecting pin 124. Then the controller 16 disconnects supply from the power source terminal 18 to the slot 12.

When the first detecting pin 124 is connected to the second detecting pin 122 through the first detecting finger 224 and the second detecting finger 222. The first detecting pin 124 is connected to ground. The controller 16 receives a low level voltage signal from the first detecting pin 124. The controller 16 is triggered to connect the power source terminal 18 to the slot 12 to supply power to the expansion card 20.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A detecting system comprising:
a slot, the slot comprising a first detecting pin and a second detecting pin, the first detecting pin being electrically connected to a detecting voltage terminal, the second detecting pin being connected to ground;
a controller being electrically connected to the first detecting pin, wherein the controller receives a high level voltage signal from the first detecting pin when an expansion card is not detected; and
a power source terminal connected to the slot under control of the controller
wherein on the condition that the first detecting pin is electrically connected to the second detecting pin, the controller receives a low level voltage signal from the first detecting pin, and the controller is triggered to connect the power source terminal to the slot to supply power to the expansion card; on the condition that first detecting pin is not electrically connected to the second detecting pin, the controller receives the high level voltage signal from the first detecting pin, and the controller prevents the power source terminal from supplying power to the slot.

2. The detecting system of claim 1, wherein the slot further comprises a power source pin, and the power source is connected to the power source pin.

3. The detecting system of claim 1, wherein the first detecting pin is electrically connected to the detecting voltage terminal via a resistor.

4. The detecting system of claim 1, wherein the first detecting pin is formed at one distal end of the slot, and the second detecting pin is formed at an opposite distal end of the slot.

5. A computer system comprising:
a motherboard, the motherboard comprising:
a slot, the slot comprising a first detecting pin and a second detecting pin, the first detecting pin being electrically connected to a detecting voltage terminal, the second detecting pin being connected to ground;
a controller being electrically connected to the first detecting pin; and
a power source terminal connected to the slot, wherein the controller is capable of preventing the power source terminal from supplying power to the slot when a high level voltage signal is received from the first detecting pin, and the controller is capable of supplying the power source terminal to the slot when a low level voltage signal is received from the first detecting pin.

6. The computer system of claim 5, wherein the controller is capable of receiving the low level voltage signal when the first detecting pin is connected to the second detecting pin.

7. The computer system of claim 5 further comprising an expansion card, the expansion card comprising a first detecting finger configured for coupling to the first detecting pin and a second detecting finger configured for coupling to the second detecting pin, the first detecting finger being electrically connected to the second detecting finger, and the controller is capable of receiving the low level voltage signal when the expansion card is properly inserted into the slot.

8. The computer system of claim 7, wherein the expansion card further comprises an inserting portion, the first detecting finger and the second detecting finger are formed on the inserting portion, and at least one of the first detecting finger and the second detecting finger has a distance away from an insertion edge of the inserting portion.

9. The computer system of claim 7, wherein the slot further comprises a power source pin, and the power source terminal is connected to the power source pin, the expansion card further comprises a power source finger coupled to the power source pin, and the expansion card receives power source through the power source pin.

10. The computer system of claim 5, wherein the first detecting pin is electrically connected the detecting voltage terminal via a resistor.

11. The computer system of claim 5, wherein the first detecting pin is formed at one end of the slot, and the second detecting pin is formed at an opposite end of the slot.
